(19) United States
(12) Patent Application Publication
(10) Pub. No.: US 2025/0142578 A1
(43) Pub. Date: May 1, 2025

(54) IMPROVING PERFORMANCE FOR CELLULAR COMMUNICATION WITH REDUCED BANDWIDTH

(71) Applicant: NOKIA TECHNOLOGIES OY, Espoo (FI)

(72) Inventors: Esa Tapani TIIROLA, Oulu (FI); Kari Juhani HOOLI, Oulu (FI); Sami-Jukka HAKOLA, Kempele (FI); Jorma Johannes KAIKKONEN, Oulu (FI); Pasi Eino Tapio KINNUNEN, Oulu (FI)

(21) Appl. No.: 18/692,256

(22) PCT Filed: Sep. 17, 2021
(86) PCT No.: PCT/EP2021/075607

§ 371 Date: Mar. 14, 2024

(51) Int. Cl. H04W 72/23

(52) U.S. Cl. CPC H04W 72/23

(57) ABSTRACT

A method comprising receiving an indication of modifying of at least one control channel element structure within an initial control resource set that is configured for an apparatus, determining at least one modified control channel element structure for at least one aggregation level in the initial control resource set, monitoring physical downlink control channel from the initial control resource set according to the modified control channel element structure, and receiving a physical downlink shared channel according to the physical downlink control channel received via the modified control channel element structure.

### FIELD

The following exemplary embodiments relate to wireless communication and to improving performance when bandwidth is reduced.

### BACKGROUND

Cellular communication enables various mobile use cases to be implemented. Various cellular communication technologies may take place alongside each other within certain frequency bandwidths. Also, for example 5G may have implementations in which narrower bandwidth than normally is used. For such narrow band use cases it is beneficial to ensure good performance also with the narrower bandwidth.

### BRIEF DESCRIPTION

The scope of protection sought for various embodiments is set out by the independent claims. The exemplary embodiments and features, if any, described in this specification that do not fall under the scope of the independent claims are to be interpreted as examples useful for understanding various embodiments of the disclosure.

According to a first aspect there is provided an apparatus comprising at least one processor, and at least one memory including a computer program code, wherein the at least one memory and the computer program code are configured, with the at least one processor, to cause the apparatus to receive an indication of modifying of at least one control channel element structure within an initial control resource set that is configured for the apparatus, determine at least one modified control channel element structure for at least one aggregation level in the initial control resource set, monitor physical downlink control channel from the initial control resource set according to the modified control channel element structure, and receive a physical downlink shared channel according to the physical downlink control channel received via the modified control channel element structure.

According to a second aspect there is provided an apparatus comprising means for receiving an indication of modifying of at least one control channel element structure within an initial control resource set that is configured for the apparatus, determining at least one modified control channel element structure for at least one aggregation level in the initial control resource set, monitoring physical downlink control channel from the initial control resource set according to the modified control channel element structure, and receiving a physical downlink shared channel according to the physical downlink control channel received via the modified control channel element structure.

According to a third aspect there is provided a method comprising receiving an indication of modifying of at least one control channel element structure within an initial control resource set that is configured for an apparatus, determining at least one modified control channel element structure for at least one aggregation level in the initial control resource set, monitoring physical downlink control channel from the initial control resource set according to the modified control channel element structure, and receiving a physical downlink shared channel according to the physical downlink control channel received via the modified control channel element structure.

According to a fourth aspect there is provided a computer program comprising instructions for causing an apparatus to perform at least the following: receive an indication of modifying of at least one control channel element structure within an initial control resource set that is configured for an apparatus, determine at least one modified control channel element structure for at least one aggregation level in the initial control resource set, monitor physical downlink control channel from the initial control resource set according to the modified control channel element structure, and receive a physical downlink shared channel according to the physical downlink control channel received via the modified control channel element structure.

According to a fifth aspect there is provided a computer program product comprising instructions for causing an apparatus to perform at least the following: receive an indication of modifying of at least one control channel element structure within an initial control resource set that is configured for an apparatus, determine at least one modified control channel element structure for at least one aggregation level in the initial control resource set, monitor physical downlink control channel from the initial control resource set according to the modified control channel element structure, and receive a physical downlink shared channel according to the physical downlink control channel received via the modified control channel element structure.

According to a sixth aspect there is provided a computer program comprising instructions stored thereon for performing at least the following: receive an indication of modifying of at least one control channel element structure within an initial control resource set that is configured for an apparatus, determine at least one modified control channel element structure for at least one aggregation level in the initial control resource set, monitor physical downlink control channel from the initial control resource set according to the modified control channel element structure, and receive a physical downlink shared channel according to the physical downlink control channel received via the modified control channel element structure.

According to a seventh aspect there is provided a non-transitory computer readable medium comprising program instructions for causing an apparatus to perform at least the following: receive an indication of modifying of at least one control channel element structure within an initial control resource set that is configured for an apparatus, determine at least one modified control channel element structure for at least one aggregation level in the initial control resource set, monitor physical downlink control channel from the initial control resource set according to the modified control channel element structure, and receive a physical downlink shared channel according to the physical downlink control channel received via the modified control channel element structure.

According to an eight aspect there is provided non-transitory computer readable medium comprising program instructions stored thereon for performing at least the following: receive an indication of modifying of at least one control channel element structure within an initial control resource set that is configured for an apparatus, determine at least one modified control channel element structure for at least one aggregation level in the initial control resource set, monitor physical downlink control channel from the initial control resource set according to the modified control channel element structure, and receive a physical downlink shared channel according to the physical downlink control channel received via the modified control channel element structure.

According to a ninth aspect there is provided an apparatus comprising at least one processor, and at least one memory including a computer program code, wherein the at least one memory and the computer program code are configured, with the at least one processor, to cause the apparatus to: transmit an indication of modifying of at least one control channel element structure for at least one aggregation level within an initial control resource set that is configured by the apparatus, transmit at least one physical downlink control channel with the at least one modified control channel element structure for the at least one aggregation level in the initial control resource set and transmit a physical downlink shared channel according to the at least one physical downlink control channel transmitted via the modified control channel element structure.

According to a tenth aspect there is provided an apparatus comprising means for transmitting an indication of modifying of at least one control channel element structure for at least one aggregation level within an initial control resource set that is configured by the apparatus, transmitting at least one physical downlink control channel with the at least one modified control channel element structure for the at least one aggregation level in the initial control resource set and transmitting a physical downlink shared channel according to the at least one physical downlink control channel transmitted via the modified control channel element structure.

According to an eleventh aspect there is provided a method comprising transmitting an indication of modifying of at least one control channel element structure for at least one aggregation level within an initial control resource set that is configured by the apparatus, transmitting at least one physical downlink control channel with the at least one modified control channel element structure for the at least one aggregation level in the initial control resource set and transmitting a physical downlink shared channel according to the at least one physical downlink control channel transmitted via the modified control channel element structure.

According to a twelfth aspect there is provided a computer program comprising instructions for causing an apparatus to perform at least the following: transmit an indication of modifying of at least one control channel element structure for at least one aggregation level within an initial control resource set that is configured by the apparatus, transmit at least one physical downlink control channel with the at least one modified control channel element structure for the at least one aggregation level in the initial control resource set and transmit a physical downlink shared channel according to the at least one physical downlink control channel transmitted via the modified control channel element structure.

According to a thirteenth aspect there is provided a computer program product comprising instructions for causing an apparatus to perform at least the following: transmit an indication of modifying of at least one control channel element structure for at least one aggregation level within an initial control resource set that is configured by the apparatus, transmit at least one physical downlink control channel with the at least one modified control channel element structure for the at least one aggregation level in the initial control resource set and transmit a physical downlink shared channel according to the at least one physical downlink control channel transmitted via the modified control channel element structure.

According to a fourteenth aspect there is provided a computer program comprising instructions stored thereon for performing at least the following: transmit an indication of modifying of at least one control channel element structure for at least one aggregation level within an initial control resource set that is configured by the apparatus; transmit at least one physical downlink control channel with the at least one modified control channel element structure for the at least one aggregation level in the initial control resource set and transmit a physical downlink shared channel according to the at least one physical downlink control channel transmitted via the modified control channel element structure.

According to a fifteenth aspect there is provided a non-transitory computer readable medium comprising program instructions for causing an apparatus to perform at least the following: transmit an indication of modifying of at least one control channel element structure for at least one aggregation level within an initial control resource set that is configured by the apparatus; transmit at least one physical downlink control channel with the at least one modified control channel element structure for the at least one aggregation level in the initial control resource set and transmit a physical downlink shared channel according to the at least one physical downlink control channel transmitted via the modified control channel element structure.

According to a sixteenth aspect there is provided non-transitory computer readable medium comprising program instructions stored thereon for performing at least the following: transmit an indication of modifying of at least one control channel element structure for at least one aggregation level within an initial control resource set that is configured by the apparatus; transmit at least one physical downlink control channel with the at least one modified control channel element structure for the at least one aggregation level in the initial control resource set and transmit a physical downlink shared channel according to the at least one physical downlink control channel transmitted via the modified control channel element structure.

### LIST OF DRAWINGS

In the following, the exemplary embodiments will be described in greater detail with reference to the embodiments and the accompanying drawings, in which

FIG. 1 illustrates an exemplary embodiment of a radio access network.

FIG. 2 illustrates an example of initial access signals and channels.

FIG. 3A illustrates an exemplary embodiment of synchronization raster points.

FIG. 3B illustrates an exemplary embodiment of DRMS allocation in PBCH PRB.

FIG. 3C illustrates an example of a pattern of a SS/PBCH block that is multiplexed by TDM, a CORESET and a PDSCH.

FIG. 4 illustrates an exemplary embodiment of possible PDCCH transmissions for CORESET #0.

FIG. 5 illustrates an example of possible PDCCH candidate sizes for AL8.

FIG. 6 illustrates an exemplary embodiment of a CORESET with offset 0 frequency location options with respect to SS/PBCH.

FIG. 7 and FIG. 8 illustrate examples of CCE mapping to REG bundles depending on the physical cell identifier.

FIG. 9 illustrates a flow chart according to an exemplary embodiment.

FIG. 10 illustrates an exemplary embodiment of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, microcontrollers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

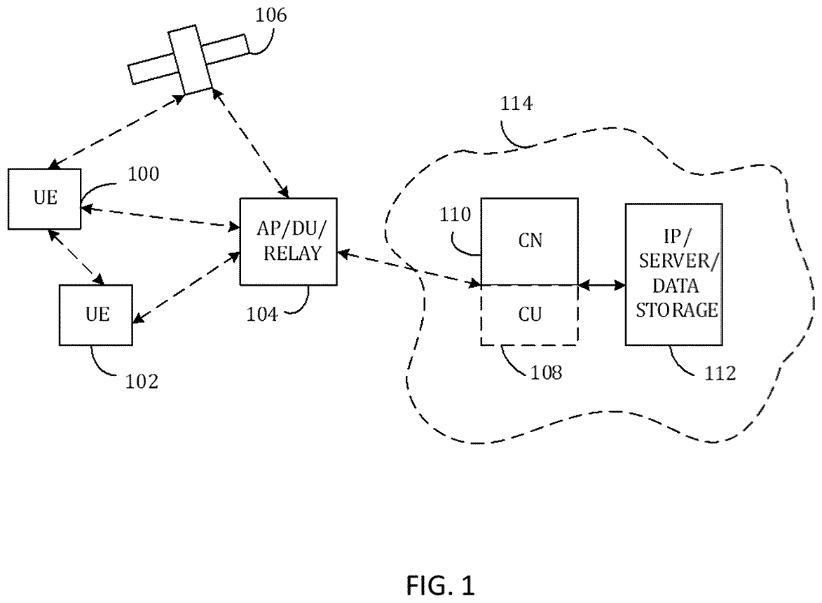

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The access node 104 may also be referred to as a node. The physical link from a terminal device to a (e/g)NodeB is called uplink or reverse link and the physical link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), etc.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. The relay node may be called as an IAB (integrated access and backhaul) node. The relay node may contain a MT (mobile termination) part, which facilitates the backhaul connection (i.e. radio link between IAB node and parent DU) and a Distributed Unit (DU) part, which facilitates the access link functionalities (i.e. radio link between IAB node and UE(s)/child IAB node(s). A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments MT part of the IAB node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility. The current solution is suitable especially for a scenario with a frequency range 1, FR1 (which covers <6 GHz), and especially frequencies below 1 GHz, has normal cyclic prefix (CP), 15 kHz subcarrier spacing and frequency division duplex (FDD). Yet, the solution may be extended for other scenarios, such as time division duplex (TDD) as well.

The current architecture in LTE networks is fully distributed in the radio and fully centralized in the core network. The low latency applications and services in 5G may require bringing the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. 5G may also utilize satellite communication to enhance or complement the coverage of 5G service, for example by providing backhauling or service availability in areas that do not have terrestrial coverage. Possible use cases comprise providing service continuity for machine-to-machine (M2M) or Internet of Things (IoT) devices or for passengers on board of vehicles, and/or ensuring service availability for critical communications, and/or future railway/maritime/aeronautical communications.

Satellite communication may utilise geostationary earth orbit (GEO) satellite systems, but also low earth orbit (LEO) satellite systems, for example, mega-constellations (systems in which hundreds of (nano)satellites are deployed). A satellite 106 comprised in a constellation may carry a gNB, or at least part of the gNB, that create on-ground cells. Alternatively, a satellite 106 may be used to relay signals of one or more cells to the Earth. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized. HAPS may be understood as radio stations located on an object at an altitude of 20-50 kilometres and at a fixed point relative to the Earth. Alternatively, HAPS may also move relative to the Earth. For example, broadband access may be delivered via HAPS using lightweight, solar-powered aircraft and airships at an altitude of 20-25 kilometres operating continually for several months for example.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

5G may also be used for narrow band operation, that is, for Narrowband New Radio (NB NR) operation. It is to be noted that NB NR may also be referred to using other terminology such as NR support for dedicated spectrum less than 5 MHz. NB NR may be useful for example to fulfil communication needs for railways, for operations relating to smart grids and/or for public safety related operations. For example, in Europe Future Railway Mobile Communication System (FRMCS) in Europe has considerations, such as an agreement to use NR with 2×5.6 MHz FDD (874.4-880 MHz/919.4-925 MHz), soft migration from GSM-R, which requires parallel operation of GSM-R and NR, that is expected to last approximately 10 years and approximately 3.6 MHz available for NR, depending on a number of parallel GSM-R channels required. Furthermore, NB NR for smart grids has the following considerations: 2×3 MHz FDD in 900 MHz in US. Public safety related scenarios have the following considerations: 2×3 MHz FDD in band 28 for Public Protection & Disaster Relief (PPDR) in Europe. In this context of this document, limited spectrum allocations (such as <5 MHz) are primarily addressed. It is to be noted that there may also be other scenarios that address other limitations such as terminal devices with reduced capabilities, including reduced bandwidth capabilities. Solutions defined for limited spectrum allocations can also support scenarios such as terminal devices with reduced bandwidth capabilities.

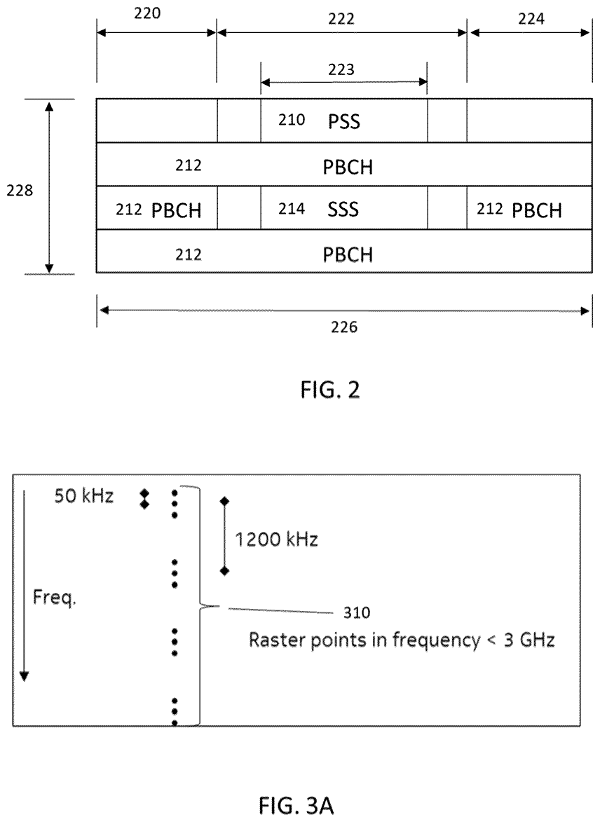

5G has been designed to operate with (min) 5 MHz channels, but to enable operations such as those described above, it may be beneficial to enable operation of 5G in a narrower bandwidth as well. For example, deployment of NR in the 900 MHz FRMCS band needs to take place alongside legacy GSM-R carriers within a 5.6 MHz bandwidth, which permits only about 3.6 MHz to be used for NR. Additionally, there may also be operations for which 3 MHz channels are available for NR. FIG. 2 illustrates initial access signals and channels with 15 kHz subcarrier spacing for 5G. In the FIG. 2, there are illustrated signals and channels of the synchronization signal and physical broadcast channel (PBCH) block (SSB) comprising primary synchronization signal (PSS) 210, secondary synchronization signal (SSS) 214 and PBCH 212. Bandwidth 220 is a 0.72 MHz Bandwidth comprising 48 subcarriers, for example 4 physical resource blocks (PRB). Bandwidth 222 is a 2.16 MHz Bandwidth comprising 144 subcarriers, for example 12 PRBs. Bandwidth 224 is a 0.72 MHz Bandwidth comprising 48 subcarriers, for example 4 PRBs. There is also illustrated a bandwidth 223 that comprises 127 subcarriers and a bandwidth 226 with 240 subcarriers, for example 20 PRBs. The SSB comprises 4 OFDM symbols as illustrated by 228.

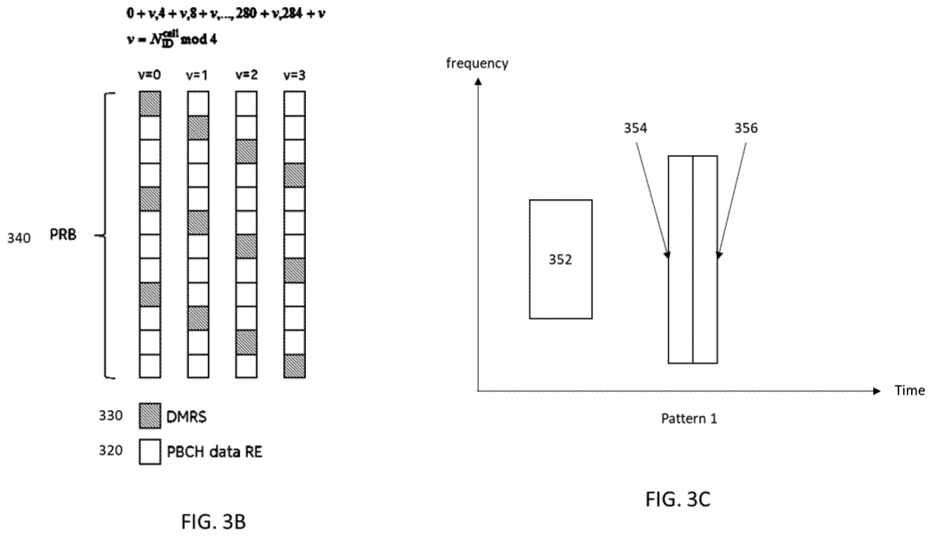

The essential signals and channels illustrated in FIG. 2 are transmitted by the NR base stations (gNBs), which, however, were not designed for transmission in such narrow channels. In an initial cell selection, in other words, in an initial access, a terminal device searches for the PSS 210 of the SSB on predefined synch raster points. In other words, the synchronization raster indicates the frequency positions of the synchronization signal block that can be used by the terminal device for system acquisition when explicit signalling of the synchronization block position is not present. A global synchronization raster is defined for all frequencies. For example, the frequency position of the SS block is defined as SSREF with corresponding number GSCN in 3GPP TS 38.101. FIG. 3A illustrates an exemplary embodiment of synchronization raster points 310 at below 3 GHz are defined in clusters of three points.

Upon detection of the PSS 210 and consequently the SSS 214 the terminal device performs demodulation of the PBCH 212 using the channel estimates calculated from the PBCH demodulation reference set (DMRS). DMRS for NR-PBCH may be mapped on every NR-PBCH symbol with density across NR-PBCH with 3 resource elements (REs)/PRB/Symbol. DMRS 330 have the same RE position in all NR-PBCH symbols 320 as illustrated FIG. 3B, which is an illustration of an exemplary embodiment of DMRS allocation in PBCH PRB 340 with four different frequency domain shifts as a function of physical cell ID.

CORESET (Control resource set) is a set of physical resources, for example, a specific area on NR Downlink Resource Grid, and a set of parameters that is used to carry PDCCH/DCI. CORESET involves many parameters configurable by RRC. CORESET #0 carries e.g. PDCCH for SIB scheduling. Yet, it cannot be configured by RRC in cases when UEs are doing the initial access to the cell from IDLE/Inactive since it is used before the RRC connection is established. Therefore, CORESET #0 is to be configured by a separate process and predefined parameters. An example of such predefined parameters and processes are summarized in Table 1 below. It is to be noted though that CORESET #0 may also be referred to as an initial CORESET, that is, an initial control resource set. CORESETs other than CORESET #0 may respectively be referred to as non-initial control resource sets.

TABLE 1

| Parameters | Pre-defined value or process |
|---|---|
| Frequency/Time | MIB_pdcch-ConfigSIB1 (38.213-13) |
| Resource Allocation | |
| Interleaving | Assumed Interleaving (38.211-7.3.2.2) |
| L (REG Bundle Size) | 6 (38.211-7.3.2.2) |
| R (Interleaver size) | 2 (38.211-7.3.2.2) |
| N_shift (Shiftindex) | N_cellID (38.211-7.3.2.2) |
| Cyclic Prefix | Normal (38.211-7.3.2.2) |
| Precoding | Same Precoding used in REG Bundle |
| | (38.211-7.3.2.2) |

Frequency/time resource allocation is given by master information block (MIB) such as PBCH using an index. For NR NB, the scenarios may comprise multiplexing Pattern 1, which is illustrated in FIG. 3C, 15 kHz SCS (for both SSB and CORESET #0), 24 RBs with 2 or 3 OFDM symbols (i.e. indexes 0-5) in accordance with Table 2, which is below. In FIG. 3C, the Pattern 1 illustrates a SS/PBCH Block 352, that is multiplexed by TDM, a CORESET 354 and a PDSCH 356.

TABLE 2

| | SS/PBCH | | | |
|---|---|---|---|---|
| | block and | | | |
| | CORESET | | Number of | |
| | multiplexing | Number- | Symbols | Offset |
| Index | pattern | of RBs | N_{RB}^{CORESET} | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

Table 2 illustrates a set of resource blocks and slot symbols of CORESET for Type0-PDCCH search space set when {SS/PBCH block, PDCCH}SCS is {15, 15} kHz for frequency bands with minimum channel bandwidth 5 MHz or 10 MHz. The terminal device determines the index, illustrated in Table 2, defining the CORESET #0 configuration based on parameter controlResourceSetZero in pdcch-ConfigSIB1 (provided by MIB/PBCH). In other words, the index of Table 2 is selected based on SSB and the index is provided in PBCH/MIB. The number of RBs in Table 2 is the number of RBs in CORESET #0 and the number of symbols refers to the number of OFDM symbols in CORESET #0. Offset in Table 2 is the offset between SSB and CORESET #0. The offset defines the offset between the lowest RB of CORESET #0 to the lowest RB of the SSB, or the RB in common resources grid overlapping with SSB.

The maximum number of PDCCH candidates monitored per PDCCH occasion are shown on Table 3 below for Type0-PDCCH search space set.

TABLE 3

| CCE Aggregation Level | Number of Candidates |
|---|---|
| 4 | 4 |
| 8 | 2 |
| 16 | 1 |

Table 3 illustrates CCE aggregation levels and maximum number of PDCCH candidates per CCE aggregation level for CSS sets configured by seachSpaceSIB1.

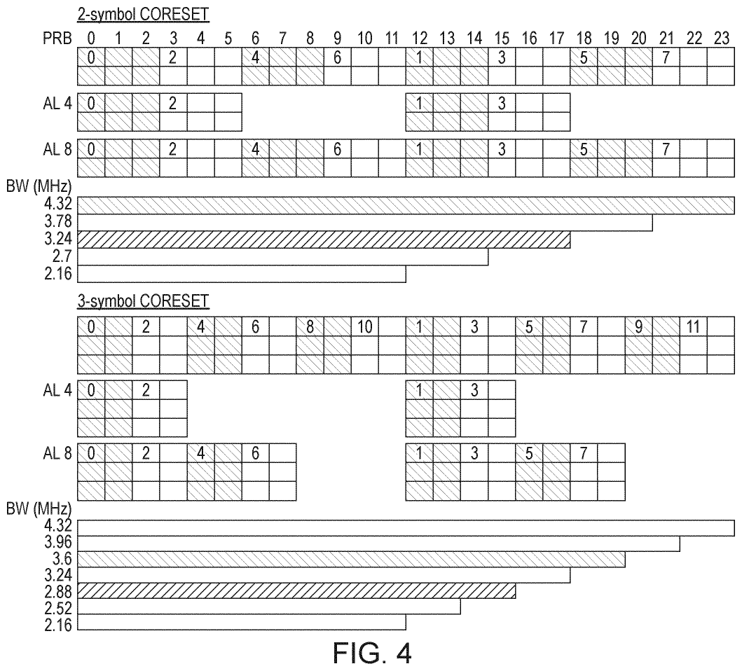

FIG. 4 illustrates an exemplary embodiment of possible PDCCH transmissions for CORESET #0. It considers both 2-symbol and 3-symbol CORESETs assuming that the number of RBs is 24 in both cases. This may be the smallest number of PRBs supported for CORESET #0. In this exemplary embodiment the transmission bandwidth is reduced from one side, such as from upper frequencies. Yet, this should not be understood as a limitation as in some exemplary embodiments the bandwidth may be reduced in other manners as well such as from both sides. However, CORESET #0 utilizes interleaved mapping between CCE and REG bundle (size=6 REGs). Because of the interleaved mapping and if 2-symbol CORESET is used, then AL8 (Aggregation level 8) cannot be transmitted without puncturing in case available bandwidth is less than 4.32 MHz. Also, the minimum bandwidth for AL4 without puncturing is 3.24 MHz and at the same time ⅓ of the PRB resources are unused. Yet, puncturing resolution other than CCE is not preferred because the terminal device is expected to average channel estimates within a CCE, which means granularity for performing puncturing is 6 PRBs which may be much higher compared to that of PBCH. Further, if a 3-symbol CORESET is used, then AL8 cannot be sent without puncturing in case there is less than 3.6 MHz of bandwidth. Yet, at the same time 20% of the PRB resources may be unused. For AL4, the minimum bandwidth, when the 3-symbol CORESET is used, is 2.88 MHz if there is no puncturing. This may result is 50% of the PRB resources being unused. Yet, puncturing resolution other than CCE is not preferred as the terminal device is expected to average channel estimates within a CCE and therefore granularity for performing puncturing is 2 PRBs, which may be much higher than that of PBCH. In some exemplary embodiments, PDCCH could occupy only 12, 13, 14 or 15 PRBs, which may be the case for example when a carrier is configured to operate according to 3 MHz channel bandwidth.

PDCCH detection performance on the other hand may suffer from puncturing, and puncturing impact on high AL PDCCH candidates may be significant. A terminal device may suffer from significant performance degradation for example in a simulation case in which one-sided puncturing of PBCH is used, additive white gaussian noise (AWGN) interference is used to mimic GSM-R interference, a gNB does not transmit PBCH on those GSM-R PRBs and a terminal device does detection assuming complete, i.e., wrong PBCH Tx BW. Table 4 below illustrates the degradation on SNR (dSNR) that is required for adequate PBCH detection performance for different amount of PRB puncturing, such as 2, 4, and 6 PRBs. The degradation on SNR is calculated with respect to SNR required for adequate detection performance of PBCH transmitted with complete BW.

TABLE 4

| “GSM” RX | dSNR [dB] | dSNR [dB] | dSNR [dB] |
|---|---|---|---|
| power | with 2 PRBs | with 4 PRBs | with 6 PRBs |
| level [dB] | compared to | compared to | compared to |
| VS PBCH | reference | reference | reference |
| −100 | 1.2 | 2.9 | 4.2 |
| −10 | 1.2 | 3.1 | 4.3 |
| −6 | 1.3 | 3.3 | 4.7 |
| −3 | 1.4 | 3.7 | 5.6 |
| 0 | 1.6 | 5.3 | 12.5 |

Depending on the interference power, PBCH detection performance may be degraded by more than 5 dB. This would result in the terminal device frequently not being able to access the cell. It is also to be noted that in deployment scenarios like GSM-R reframing, GSM and NR BS would likely be co-located to same sites, making the higher GSM power levels more probable. Thus, there is a need for PDCCH performance improvements. An aspect that is beneficial to be addressed when using only AL4 is how to support having more used CCEs with a given minimum bandwidth.

It is known that a difference in link performance between AL4 and AL8 can be more than 3 dB. Another aspect that is beneficial to be addressed is that when using also AL8, it cannot be used without puncturing. Based on PBCH results, 25% puncturing in the scenario in which terminal device does not know the actual puncturing pattern can be more than 5 dB. Thus, a benefit that is associated with exemplary embodiments described below is that optimal PDCCH detection is facilitated for correctly detecting PBCH as PDCCH BW may be separately adjusted for each PDCCH candidate while keeping the PDCCH structure unchanged.

In an exemplary embodiment, a terminal device may be instructed to monitor a common search space (CSS) in a certain manner. This manner may comprise monitoring PDCCH with a modified CCE structure for at least one AL, such as AL8, in addition to monitoring full candidates with AL4, AL8 and/or AL16. In this exemplary embodiment, the modified CCE structure corresponds to the punctured PDCCH for the given AL, but in some other exemplary embodiments, the modified CCE structure may correspond to a non-interleaved CCE-structure. In yet some other exemplary embodiments, the modified CCE structure may correspond to a new aggregation level, such as level 3, 5, 6, 7, 9, 10, 11, 12, 13, 14 or 15 (in addition to aggregation levels 1, 2, 4, 8, 16 supported by the new radio). The new aggregation levels may be used with the non-interleaved CCE-structure. In yet some other exemplary embodiments, a terminal device may perform PDCCH monitoring for SIB1 using only the modified CCE structure, in which case the terminal device is operating in a special band. The punctured candidates may be formed in a predefined manner, such as punctured from the last CCE, or from the first CCE. Additionally, the outermost CCE, from highest or lowest PRB, may be punctured with the granularity of one PRB, in which case the size of corresponding REG bundle reduces accordingly, while the size of other REG bundles is unchanged. Also, the modified CCE structure may depend on the determined channel bandwidth, for example one modified CCE structure may be applied for 3 MHz channel bandwidth (CBW), and another modified CCE structure for 5 MHz CBW. Further, a combination of the above-mentioned predefined manners may also be used for the punctured candidates. It is also to be noted that the punctured PDCCH that is punctured in the predefined manner is punctured relating to the CCEs in frequency. It is to be noted that the determined channel bandwidth may be understood as channel bandwidth that is determined to be available. The determination may be done for example by the terminal device in any suitable manner. Thus, in general, the modified CCE structure may depend on a channel bandwidth.

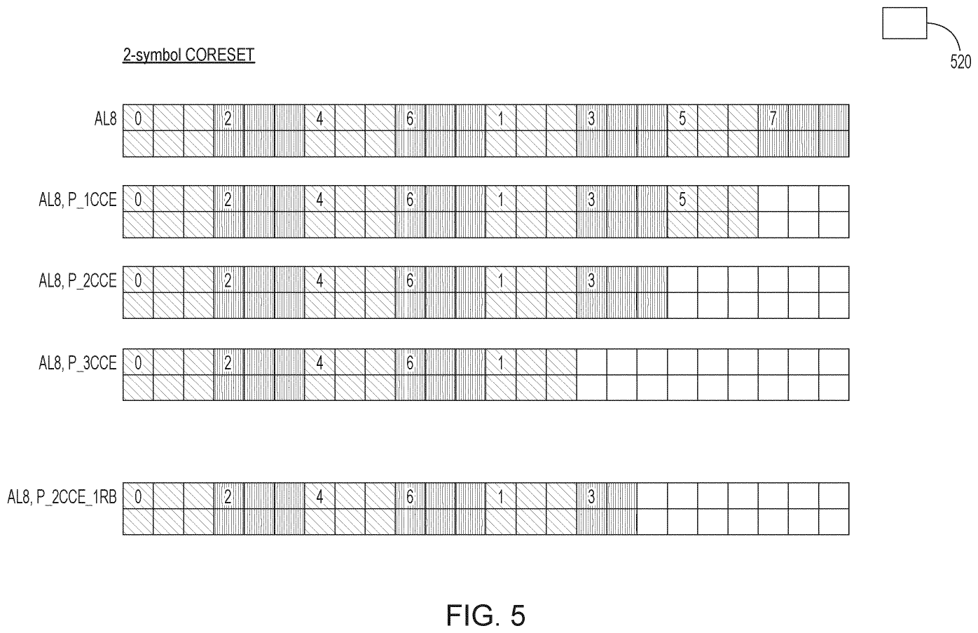

FIG. 5 illustrates an example of possible PDCCH candidate sizes for AL8. It is to be noted though that for an exemplary embodiment with 3 MHz, the modified structure may be applied already for AL4. In FIG. 5, CCE indexes are illustrated as numbers according to legacy CCE-to-REG mapping with CORESET size of 24 PRBs. In this exemplary embodiment the size of CORESET is 2 OFDM symbols times 24 PRBs. The empty CCEs 520 are punctured REGs. For CORESET sizes greater than 24, the valid CCE indexes for punctured PDCCH candidate are [x, x+2, x+4, . . . , x+M], where x is the first CCE index, given by the hashing function, and M/2 is the number of CCEs in the PDCCH candidate.

Additionally, there may be a need to configure the actual PDCCH structure for a terminal device such that the terminal device and the access node, such as a gNB, have a common understanding. For example, reserved bits may be used in PBCH or bits that are not needed may be re-interpreted. For example, it may be assumed that NR NB is restricted to {15, 15}kHz {SS/PBCH block, PDCCH} combination, in which case the 5th bit of kSSB is not needed, that is, carried in PBCH physical layer bit ā_{A+s} and can thus be repurposed for PDCCH format configuration. The format configuration may be understood as a configuration that may indicate the modified CCE structure used. Alternatively, the necessary functionality may be defined based on an existing table such as by means of additional column in the table. For example, the following combination {SS/PBCH block, PDCCH}SCS in {15, 30} may be considered as invalid for predefined NB NR frequency bands, which would provide 16 additional configuration options for PDCCH puncturing. As another example, the CORESET of more than 24 RBs may be considered as invalid for predefined NB NR frequency bands, which would provide 10 and 8 additional configuration options for PDCCH puncturing for {15, 15}kHz and {15, 30}kHz {SS/PBCH block, PDCCH} combinations, respectively. As a further example, the previous example may be combined such that another table is defined for {SS/PBCH block, PDCCH}SCS is {15, 15}, and this additional table includes instructions on how to modify the CCE structure. For example, a reserved bit may indicate which table to follow, that is, legacy or new table.

In one exemplary embodiment, the signalling solution defined above may only be applied when monitoring PDCCH for SIB1 and in other situations, such as with CORESET #0, the terminal device becomes aware of the actual puncturing based on SIB1 or based on other higher layer signalling. Based on the actual puncturing the terminal device may then optimize the PDCCH monitoring including PDCCH puncturing pattern according to the actual Tx BW configuration. Yet, it is to be noted that in some other exemplary embodiments, the modified CCE structure may always be applied with CORESET #0.

The maximum number of PDCCH candidates monitored per PDCCH occasion are illustrated in table 5 below. Table 5 illustrates CCE aggregation levels and maximum number of PDCCH candidates per CCE aggregation level for CSS sets configured by searchSpaceSIB1. In this exemplary embodiment it is assumed that the maximum number of PDCCH candidates per CCE aggregation level is maintained, but the CCE structure among candidates is varied in a predefined manner. The numbers in brackets represent different shares between legacy structure and new structure (e.g. [3]+[1]).

TABLE 5

| CCE | Number | | |
|---|---|---|---|
| Aggregation | of | | |
| Level | Candidates | Current structure | New structure |
| 4 | 4 | [3, 2, 1, (0)] | [1, 2, 3, (4)] |
| 8 | 2 | [1, (0)] | [1, (2)] |
| 16 | 1 | [1, (0)] | [0, (1)] |

The relative frequency location of the CORESET and SS/PBCH block is given on PBCH. It is controlled by the offset that may be provided in a table and quantity k_{SSB} signalled on PBCH. The offset is from the smallest RB index of the CORESET to the smallest RB index of the common RB overlapping with the first RB of the corresponding SS/PBCH block, and k_{SSB} provides the SS/PBCH location with respect to the common RB grid and it is the subcarrier offset from subcarrier 0 in common resource block N_{CRB}^{SSB} to subcarrier 0 of the SS/PBCH block.

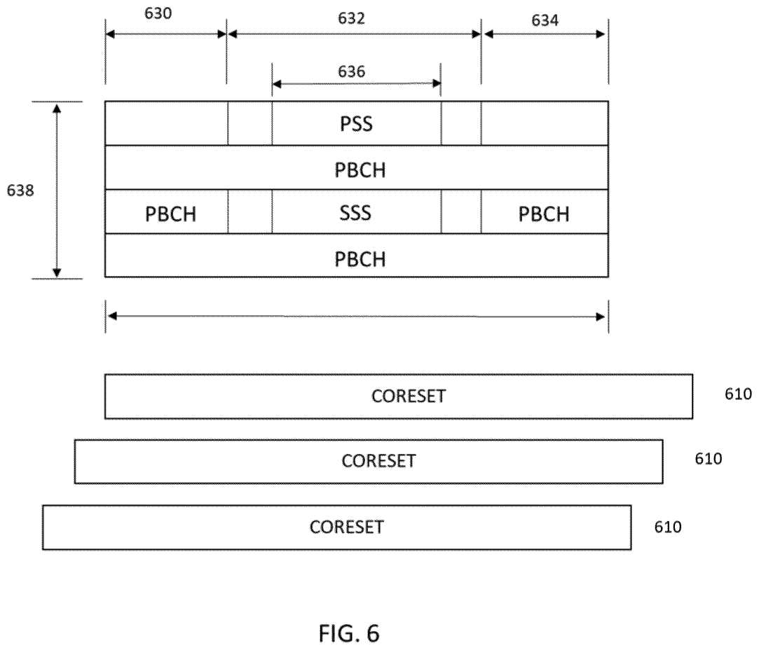

When the CORESET occupies 24 RBs with 15 kHz SCS, the offset may have any of the values 0, 2, or 4. When k_{SSB} aligns the SS/PBCH block with the common RB, the offset may locate CORESET symmetrically with respect to SS/PBCH block, or align the CORESET lower/higher frequency edge with the PBCH lower/higher frequency edge, respectively, as is illustrated in FIG. 6. In FIG. 6, CORESET with offset 0 frequency location options 610 with respect to SS/PBCH, when aligned with common RB. In FIG. 6 there are illustrated PSS, SSS and PBCH. Bandwidth 630 is a 0.72 MHz bandwidth comprising 48 subcarriers, for example 4 PRBs. Bandwidth 632 is a 2.16 MHz Bandwidth comprising 144 subcarriers, for example 12 PRBs. Bandwidth 634 is a 0.72 MHz Bandwidth comprising 48 subcarriers, for example 4 PRBs. There is also illustrated a bandwidth 223 that comprises 127 subcarriers and a bandwidth 636 with 240 subcarriers, for example 20 PRBs. The SSB comprises 4 OFDM symbols as illustrated by 638.

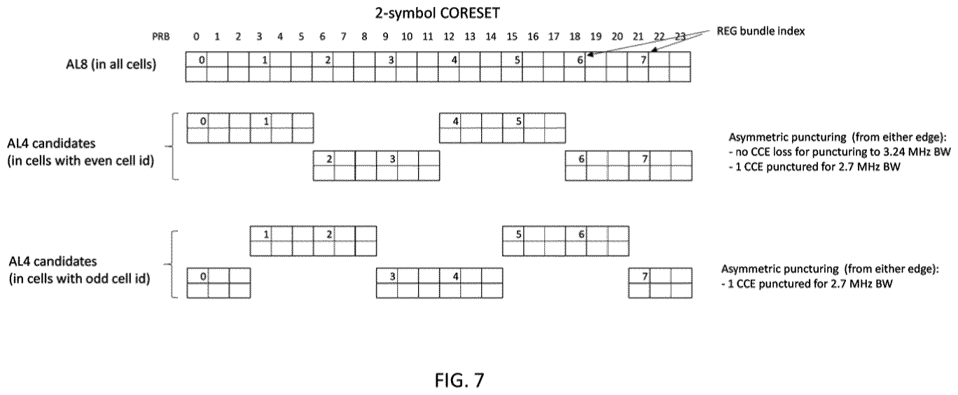

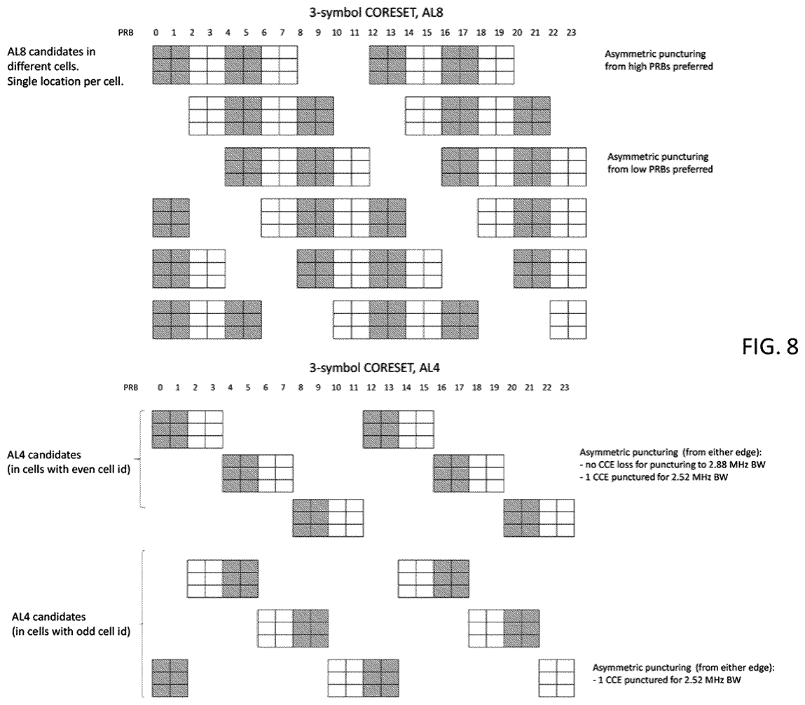

The CCE mapping to REG bundles depends on the physical cell identifier as is illustrated in FIG. 7 and FIG. 8. It is be noted that with some cell IDs CCE puncturing on PDCCH candidates may start to occur with narrower BWs than with other cell IDs. Therefore, in some exemplary embodiments, a subset of cell IDs may be used in NB NR deployments, for example for cells with wide range. Alternatively, a non-interleaved mapping may be used for some cell IDs. In the case of non-interleaved mapping, CCEs are mapped to REG bundles in increasing order of CCE and REG bundle indexes. Correspondingly, asymmetric mapping from high PRBs may be used together with CORESET offset of 0 such that lower PRBs are aligned with the SS/PBCH block. By limiting asymmetric puncturing to puncturing from higher PRBs only, as asymmetric puncturing from lower PRBs may not be supported, signalling states are saved for other purposes, which is beneficial as signalling states may be scarce.

Table 6 below illustrates an example of puncturing functionality defined based on an invalid {SS/PBCH block, PDCCH}SCS combination {15, 30} for considered (NR NB) frequency bands. In this example, the desired functionality is achieved by selecting the desired row based on MIB and the additional column indicates how the CCE structure for the predefined CCEs is constructed. For example, puncturing CCEs/CCEs+outermost RBs. In this example index 5 illustrates symmetric puncturing around the CORESET. In other examples asymmetric puncturing, puncturing CCE/RBs from the highest frequencies, may be assumed. In table 6, a set of resource blocks and slot symbols of CORESET for Type0-PDCCH search space set when {SS/PBCH block, PDCCH}SCS is {15, 30}kHz for frequency bands with minimum channel bandwidth 5 MHz or 10 MHz.

TABLE 6

| | SS/PBCH | | | | |
|---|---|---|---|---|---|
| | block and | | | | |
| | CORESET | Number | Number of | Offset | |
| | multiplexing | of RBs | Symbols | (RBs) | CCE mapping for |
| Index | pattern | N_{RB}^{CORESET} | N_{symb}^{CORESET} | N_{symb}^{CORESET} | predefined AL(s) |
| 0 | 1 | 24 | 2 | 0 | Puncture CCE [7] |
| 1 | 1 | 24 | 2 | 0 | Puncture CCE [5, 7] |
| 2 | 1 | 24 | 2 | 0 | Puncture CCE [3, 5, 7] |
| 3 | 1 | 24 | 2 | 0 | Puncture CCE [3, 5, 7] |
| 4 | 1 | 24 | 2 | 0 | Puncture CCE [3, 5] + |
| | | | | | 1PRB from CCE [3] |
| 5 | 1 | 24 | 2 | 2 | Puncture CCE [0 7] |
| | | | | | (symmetric) |
| 6 | 1 | 24 | 2 | 0 | Non-interleaved mapping |
| 7 | 1 | 24 | 3 | 0 | Puncture CCE [7] |
| 8 | 1 | 24 | 3 | 0 | Puncture CCE [5, 7] |
| 9 | 1 | 24 | 3 | 0 | Puncture CCE [7] + 1PRB |
| | | | | | from CCE[3] |
| 10 | 1 | 24 | 3 | 0 | Non-interleaved mapping |
| 11 | 1 | 24 | 3 | 0 | Non-interleaved mapping |
| | | | | | Puncture 1Rb from CCE 7 |
| 12 | 1 | 24 | 3 | 0 | Non-interleaved mapping |
| | | | | | Puncture CCE 7 |
| 13 | 1 | 24 | 3 | 0 | Non-interleaved mapping |
| | | | | | Puncture CCE [7] + 1RB |
| | | | | | from CCE [6] |
| 14 | 1 | 24 | 3 | 0 | Non-interleaved mapping |
| | | | | | Puncture CCE [6 7] |

| | |
|---|---|
| 15 | Reserved |

Alternatively, the puncturing may be defined in terms of REG bundle index, in which case also punctured AL16 may be supported as illustrated in Table 7.

TABLE 7

| | SS/PBCH | | | | |
|---|---|---|---|---|---|
| | block and | | | | |
| | CORESET | | | | |
| | multi- | Number | Number of | | CCE mapping |
| | plexing | of RBs | Symbols | Offset | for predefined |
| Index | pattern | N_{RB}^{CORESET} | N_{symb}^{CORESET} | (RBs) | AL(s) |
| 0 | 1 | 24 | 2 | 0 | Puncture REG |
| | | | | | bundle [7] + 1 |
| | | | | | RB from REG |
| | | | | | bundle [6] |
| 1 | 1 | 24 | 2 | 0 | Puncture REG |
| | | | | | bundle [6, 7] |
| 2 | 1 | 24 | 2 | 0 | Puncture REG |
| | | | | | bundle [5, 6, 7] |
| 3 | 1 | 24 | 2 | 0 | Puncture [6, 7] + |
| | | | | | 1 RB from REG |
| | | | | | bundle [5] |
| 4 | 1 | 24 | 2 | 2 | Puncture REG |
| | | | | | bundle [0, 7] |
| 5 | 1 | 24 | 2 | 0 | Non-interleaved |
| | | | | | mapping |
| | | | | | puncture REG |
| | | | | | bundle [7] + 1 |
| | | | | | RB from REG |
| | | | | | bundle [6] |
| 6 | 1 | 24 | 2 | 0 | Non-interleaved |
| | | | | | mapping |
| | | | | | puncture |
| | | | | | REG bundle |
| | | | | | [6, 7] |
| 7 | 1 | 24 | 3 | 0 | Puncture REG |
| | | | | | bundle [10, 11] |
| 8 | 1 | 24 | 3 | 2 | Puncture REG |
| | | | | | bundle [0, 11] |
| 9 | 1 | 24 | 3 | 0 | Puncture REG |
| | | | | | bundle |
| | | | | | [8, 9, 10, 11] |
| 10 | 1 | 24 | 3 | 2 | Puncture REG |
| | | | | | bundle |
| | | | | | [0, 1, 10, 11] |
| 11 | 1 | 24 | 3 | 0 | Non-interleaved |
| | | | | | mapping |
| 12 | 1 | 24 | 3 | 0 | Non-interleaved |
| | | | | | mapping |
| | | | | | puncture REG |
| | | | | | bundle [10, 11] |
| 13 | 1 | 24 | 3 | 0 | Non-interleaved |
| | | | | | mapping |
| | | | | | puncture |
| | | | | | REG bundle |
| | | | | | [8, 9, 10, 11] |
| 14 | 1 | 24 | 3 | 0 | Non-interleaved |
| | | | | | mapping |
| | | | | | puncture |
| | | | | | REG bundle |
| | | | | | [6, 7, 8, 9, 10, 11] |
| 15 | | | | | |

In one exemplary embodiment, signalling occurs in downlink RF channel 919.4-925 MHz for the FRMCS. In this exemplary embodiment there are only six valid sync raster points: N {768, 769}, M={1, 2, 3}. Additionally, only SSB-CORESET #0 offsets 0 and 4 are applicable and therefore in CORESET #0 configuration table only configuration indices 0, 2, 3 and 5 are applicable and there are 12 unusable entries. In the CORESET #0 configuration, the 4 entries would be feasible as illustrated in Table 8 below.

TABLE 8

| | SS/PBCH | | | |
|---|---|---|---|---|
| | block and | | | |
| | CORESET | Number | Number of | |
| | multiplexing | of RBs | Symbols | Offset |
| Index | pattern | N_{RB}^{CORESET} | N_{symb}^{CORESET} | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

Therefore, in one exemplary embodiment, the signalling for a terminal device may be such that there are own tables defined for 2-symbol and 3-symbol CORESET #0 configurations. The selection of which table to apply may be provided by re-interpreting the subCarrierSpacingCommon field in MIB (PBCH) or 5th (MSB) of kSSB. The selection may also be provided via reserved field in MIB. Table 9 below illustrates a set of resource blocks and slot symbols of CORESET for Type0-PDCCH search space set when {SS/PBCH block, PDCCH}SCS is {15, 15}kHz for frequency bands with minimum channel bandwidth 5 MHz with Number of Symbols equal to 2 (subCarrierSpacingCommon=0).

TABLE 9

| | SS/PBCH | | | | |
|---|---|---|---|---|---|
| | block and | | | | CCE |
| | CORESET | | | | mapping |
| | multi- | Number | Number of | | for |
| | plexing | of RBs | Symbols | Offset | predefined |
| Index | pattern | N_{RB}^{CORESET} | N_{symb}^{CORESET} | (RBs) | AL(s) |
| 0 | 1 | 24 | 2 | 0 | Puncture CCE |
| | | | | | [7] |
| 1 | 1 | 24 | 2 | 0 | Puncture CCE |
| | | | | | [5, 7] |
| 2 | 1 | 24 | 2 | 0 | Puncture CCE |
| | | | | | [3, 5, 7] |
| 3 | 1 | 24 | 2 | 0 | Puncture |
| | | | | | [5, 7] + 1 CCE |
| | | | | | [3] |
| 4 | 1 | 24 | 2 | 0 | Non- |
| | | | | | interleaved |
| | | | | | mapping |
| 5 | 1 | 24 | 2 | 0 | Non- |
| | | | | | interleaved |
| | | | | | mapping |
| | | | | | puncture 1 |
| | | | | | CCE [7] |
| 6 | 1 | 24 | 2 | 0 | Non- |
| | | | | | interleaved |
| | | | | | mapping |
| | | | | | puncture CCE |
| | | | | | [7] |
| 7 | 1 | 24 | 2 | 0 | Non- |
| | | | | | interleaved |
| | | | | | mapping |
| | | | | | puncture CCE |
| | | | | | [7] + 1 |
| | | | | | CCE [6] |
| 8 | 1 | 24 | 2 | 4 | Puncture CCE |
| | | | | | [7] |
| 9 | 1 | 24 | 2 | 4 | Puncture CCE |
| | | | | | [5, 7] |
| 10 | 1 | 24 | 2 | 4 | Puncture CCE |
| | | | | | [3, 5, 7] |
| 11 | 1 | 24 | 2 | 4 | Puncture |
| | | | | | [5, 7] + 1 CCE |
| | | | | | [3] |
| 12 | 1 | 24 | 2 | 4 | Non- |
| | | | | | interleaved |
| | | | | | mapping |
| 13 | 1 | 24 | 2 | 4 | Non- |
| | | | | | interleaved |
| | | | | | mapping |
| | | | | | puncture 1 |
| | | | | | CCE [7] |
| 14 | 1 | 24 | 2 | 4 | Non- |
| | | | | | interleaved |
| | | | | | mapping |
| | | | | | puncture CCE |
| | | | | | [7] |
| 15 | 1 | 24 | 2 | 4 | Non- |
| | | | | | interleaved |
| | | | | | mapping |
| | | | | | puncture CCE |
| | | | | | [7] + 1 |
| | | | | | CCE [6] |

Table 10 illustrates a set of resource blocks and slot symbols of CORESET for Type0-PDCCH search space set when {SS/PBCH block, PDCCH}SCS is {15, 15}kHz for frequency bands with minimum channel bandwidth 5 MHz with Number of Symbols equal to 3 (subCarrierSpacingCommon=1).

TABLE 10

| | SS/PBCH | | | | |
|---|---|---|---|---|---|
| | block and | | | | CCE |
| | CORESET | | | | mapping |
| | multi- | Number | Number of | | for |
| | plexing | of RBs | Symbols | Offset | predefined |
| Index | pattern | N_{RB}^{CORESET} | N_{symb}^{CORESET} | (RBs) | AL(s) |
| 0 | 1 | 24 | 3 | 0 | Puncture CCE |
| | | | | | [7] |
| 1 | 1 | 24 | 3 | 0 | Puncture CCE |
| | | | | | [5, 7] |
| 2 | 1 | 24 | 3 | 0 | Puncture CCE |
| | | | | | [3, 5, 7] |
| 3 | 1 | 24 | 3 | 0 | Puncture |
| | | | | | [5, 7] + 1 CCE |
| | | | | | [3] |
| 4 | 1 | 24 | 3 | 0 | Non- |
| | | | | | interleaved |
| | | | | | mapping |
| 5 | 1 | 24 | 3 | 0 | Non- |
| | | | | | interleaved |
| | | | | | mapping |
| | | | | | puncture 1 |
| | | | | | CCE [7] |
| 6 | 1 | 24 | 3 | 0 | Non- |
| | | | | | interleaved |
| | | | | | mapping |
| | | | | | puncture |
| | | | | | CCE [7] |
| 7 | 1 | 24 | 3 | 0 | Non- |
| | | | | | interleaved |
| | | | | | mapping |
| | | | | | puncture |
| | | | | | CCE [7] + 1 |
| | | | | | CCE [6] |
| 8 | 1 | 24 | 3 | 4 | Puncture CCE |
| | | | | | [7] |
| 9 | 1 | 24 | 3 | 4 | Puncture CCE |
| | | | | | [5, 7] |
| 10 | 1 | 24 | 3 | 4 | Puncture CCE |
| | | | | | [3, 5, 7] |
| 11 | 1 | 24 | 3 | 4 | Puncture |
| | | | | | [5, 7] + 1 CCE |
| | | | | | [3] |
| 12 | 1 | 24 | 3 | 4 | Non- |
| | | | | | interleaved |
| | | | | | mapping |
| 13 | 1 | 24 | 3 | 4 | Non- |
| | | | | | interleaved |
| | | | | | mapping |
| | | | | | puncture 1 |
| | | | | | CCE [7] |
| 14 | 1 | 24 | 3 | 4 | Non- |
| | | | | | interleaved |
| | | | | | mapping |
| | | | | | puncture |
| | | | | | CCE [7] |
| 15 | 1 | 24 | 3 | 4 | Non- |
| | | | | | interleaved |
| | | | | | mapping |
| | | | | | puncture |
| | | | | | CCE [7] + 1 |
| | | | | | CCE [6] |

In an alternative exemplary embodiment, own tables may be defined for 0 and 4 RB offsets and have the 2-symbol and 3-symbol configurations in the same table per offset (0 or 4). The selection of which table to select may be provided e.g. by the subCarrierSpacingCommon. The selection could also be based on sync raster position such that if the terminal device detects PSS on synch raster point as a function of N=768, the terminal device determines offset being 0 and corresponding table. Also, if the terminal device detects PSS on synchronization raster point as a function of N=769, the terminal device determines offset being 4 and corresponding table. The selection may also be provided via re-interpreted/reserved field in MIB.

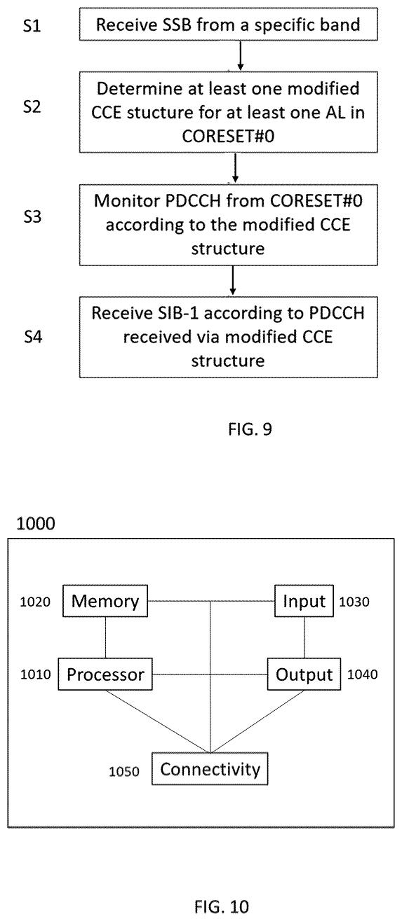

FIG. 9 illustrates a flow chart according to an exemplary embodiment. In S1, a terminal device receives an SSB from a specific band. Then, in S2, the terminal device determines at least one modified CCE structure for at least one AL in CORESET #0. Next, in S3, the terminal device monitors PDCCH from CORESET #0 according to the modified CCE structure. Finally, in S4, the terminal device receives SIB-1 according to PDCCH received via modified CCE structure. In some exemplary embodiments, the gNB may define when to transmit PDCCH for SIB1. In other words, the terminal device may not (always) receive Type0 PDCCH and thus SIB1 received via PDSCH that is not present accordingly. It is also to be noted that the modified CCE structure may be used to increase the number of transmitted PRBs or CCEs for PDCCH within a total number of available PRBs, which may be for example less than 24 PRBs. It is further also to be noted that the mechanism to receive the SIB1 is that of receiving a physical downlink shared channel (PDSCH) and that same mechanism may be used to receive other system information (SIB-x) and paging as well. Thus, in general, the terminal device may receive a PDSCH in S4 and that PDSCH may be transmitted by an access node such as a gNB.

The exemplary embodiments described above have advantages such as requiring only a small change for the implementation, for example changes to the interleaving pattern can be avoided, allowing fine granularity for bandwidth adjustment, such as up-to one PRB or even less, which may maximize the PDCCH performance. Also, the exemplary embodiments described above may be done without additional signalling overhead. UE PDCCH monitoring burden may be kept unchanged and PDCCH hashing function may also be unchanged. The exemplary embodiments described above are easy from gNB point of view, as just puncturing, and proper MIB indication are required. It is also to be noted that in the context of this document, a table may be understood as a look-up table of values from which a correct configuration and/or values can be determined. The table may be pre-determined, that is, an existing table or any other suitable table. Further, the table may be a table associated with a CORESET, such as an initial CORESET.

FIG. 10 illustrates an apparatus 1000, which may be an apparatus such as, or comprised in, a terminal device, according to an example embodiment. The apparatus 1000 comprises a processor 1010. The processor 1010 interprets computer program instructions and processes data. The processor 1010 may comprise one or more programmable processors. The processor 1010 may comprise programmable hardware with embedded firmware and may, alternatively or additionally, comprise one or more application specific integrated circuits, ASICs.

The processor 1010 is coupled to a memory 1020. The processor is configured to read and write data to and from the memory 1020. The memory 1020 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 1020 stores computer readable instructions that are execute by the processor 1010. For example, non-volatile memory stores the computer readable instructions and the processor 1010 executes the instructions using volatile memory for temporary storage of data and/or instructions.

The computer readable instructions may have been pre-stored to the memory 1020 or, alternatively or additionally, they may be received, by the apparatus, via electromagnetic carrier signal and/or may be copied from a physical entity such as computer program product. Execution of the computer readable instructions causes the apparatus 1000 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 1000 further comprises, or is connected to, an input unit 1030. The input unit 1030 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 1030 may comprise an interface to which external devices may connect to.

The apparatus 1000 also comprises an output unit 1040. The output unit comprises or is connected to one or more displays capable of rendering visual content such as a light emitting diode, LED, display, a liquid crystal display, LCD and a liquid crystal on silicon, LCoS, display. The output unit 1040 further comprises one or more audio outputs. The one or more audio outputs may be for example loudspeakers or a set of headphones.

The apparatus 1000 may further comprise a connectivity unit 1050. The connectivity unit 1050 enables wired and/or wireless connectivity to external networks. The connectivity unit 1050 may comprise one or more antennas and one or more receivers that may be integrated to the apparatus 1000 or the apparatus 1000 may be connected to. The connectivity unit 1050 may comprise an integrated circuit or a set of integrated circuits that provide the wireless communication capability for the apparatus 1000. Alternatively, the wireless connectivity may be a hardwired application specific integrated circuit, ASIC.

It is to be noted that the apparatus 1000 may further comprise various component not illustrated in the FIG. 10. The various components may be hardware component and/or software components.

Even though the disclosure has been described above with reference to an example according to the accompanying drawings, it is clear that the disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor, and at least one memory including a computer program code, wherein the at least one memory and the computer program code are configured, with the at least one processor, to cause the apparatus to:
receive information comprising at least one control channel element structure associated with at least one aggregation level within an initial control resource set that is configured for the apparatus;
receive an indication of modifying of the at least one control channel element structure;
modify the at least one control channel element structure while the at least one aggregation level is maintained;
monitor a physical downlink control channel from the initial control resource set according to the modified control channel element structure; and
receive a physical downlink shared channel according to the physical downlink control channel received via the modified control channel element structure.

2. An apparatus according to claim 1, wherein the apparatus is further caused to:
modify the at least one control channel element structure by puncturing the at least one control channel element structure.

3. An apparatus according to claim 2, wherein the physical downlink control channel is obtained by puncturing from a last and/or a first control channel element.

4. An apparatus according to claim 1, wherein the modified control channel element structure corresponds to a non-interleaved control channel element structure.

5. An apparatus according to claim 2, wherein one or more control channel elements from highest or lowest physical resource block are punctured with a granularity of one physical resource block.

6. An apparatus according to claim 1, wherein the modified control channel element structure depends on a channel bandwidth.

7. An apparatus according to claim 1, wherein one or more bits comprised in a physical broadcast channel are used for configuration of the physical downlink control channel, wherein the configuration indicates the modified control channel element structure that is used.

8. An apparatus according to claim 1, wherein configuration of puncturing of the physical downlink control channel is based on a table associated with the initial control resource set.

9. An apparatus according to claim 1, wherein the apparatus is further caused to:
monitor a specific frequency band; and
receive a synchronization signal block from the specific frequency band for the physical downlink control channel monitoring.

10. An apparatus according to claim 1, wherein the apparatus is a terminal device, and the terminal device is further caused to:
uses the modified control channel element structure to detect at least Type0 physical downlink control channel.

11. An apparatus comprising at least one processor, and at least one memory including a computer program code, wherein the at least one memory and the computer program code are configured, with the at least one processor, to cause the apparatus to:
transmit information comprising at least one control channel element structure associated with at least one aggregation level within an initial control resource set that is configured by the apparatus;
transmit an indication of modifying of the at least one control channel element structure;
transmit at least one physical downlink control channel with the at least one modified control channel element structure in the initial control resource set; and
transmit a physical downlink shared channel according to the at least one physical downlink control channel transmitted via the modified control channel element structure.

12. An apparatus according to claim 11, wherein the modified control channel element structure corresponds to a punctured physical downlink control channel.

13. An apparatus according to claim 12, wherein the punctured physical downlink control channel is obtained by puncturing from a last and/or a first control channel element.

14. An apparatus according to claim 11, wherein the modified control channel element structure corresponds to a non-interleaved control channel element structure.

15. An apparatus according to claim 12, wherein one or more control channel element from highest or lowest physical resource block are punctured with a granularity of one physical resource block.

16. An apparatus according to claim 11, wherein the modified control channel element structure depends on a channel bandwidth.

17. An apparatus according to claim 11, wherein one or more bits comprised in a physical broadcast channel are used for configuration of the physical downlink control channel, wherein the configuration indicates the modified control channel element structure that is used.

18. An apparatus according to claim 11, wherein configuration of puncturing of the physical downlink control channel is based on a table associated with the initial control resource set.

19. A method comprising:
receiving information comprising at least one control channel element structure associated with at least one aggregation level within an initial control resource set that is configured for an apparatus;
receiving an indication of modifying of the at least one control channel element structure;
modifying the at least one control channel element structure while the at least one aggregation level is maintained;
monitoring a physical downlink control channel from the initial control resource set according to the modified control channel element structure; and
receiving a physical downlink shared channel according to the physical downlink control channel received via the modified control channel element structure.

20. A method comprising:
transmitting information comprising at least one control channel element structure associated with at least one aggregation level within an initial control resource set that is configured by an apparatus;
transmitting an indication of modifying of the at least one control channel element structure;
transmitting at least one physical downlink control channel with the at least one modified control channel element structure in the initial control resource set; and
transmitting a physical downlink shared channel according to the at least one physical downlink control channel transmitted via the modified control channel element structure.

21. A non-transitory computer readable medium comprising program instructions for causing an apparatus to perform at least the following:
receive information comprising at least one control channel element structure associated with at least one aggregation level within an initial control resource set that is configured for the apparatus;
receive an indication of modifying of the at least one control channel element structure;
modify the at least one control channel element structure while the at least one aggregation level is maintained;
monitor a physical downlink control channel from the initial control resource set according to the modified control channel element structure; and
receive a physical downlink shared channel according to the physical downlink control channel received via the modified control channel element structure.

22. A non-transitory computer readable medium comprising program instructions for causing an apparatus to perform at least the following:
transmit information comprising at least one control channel element structure associated with at least one aggregation level within an initial control resource set that is configured by the apparatus;
transmit an indication of modifying of the at least one control channel element structure;
transmit at least one physical downlink control channel with the at least one modified control channel element structure in the initial control resource set; and
transmit a physical downlink shared channel according to the at least one physical downlink control channel transmitted via the modified control channel element structure.
